(19) United States
(12) Patent Application Publication
(10) Pub. No.: US 2020/0161905 A1
(43) Pub. Date: May 21, 2020

(54) Living Object Protection and Foreign Object Protection for a Wireless Power Transmission System and Method for Operating a Wireless Power Transmission System

(71) Applicant: TDK Corporation, Tokyo (JP)

(72) Inventor: Pierre Fechting, Solothurn (CH)

(21) Appl. No.: 16/626,260

(22) PCT Filed: Jun. 22, 2017
(86) PCT No.: PCT/EP2017/065435

§ 371 Date: Dec. 23, 2019

(51) Int. Cl. H02J 50/60; H02J 50/10; B60L 53/124; G01V 3/08; G01V 3/10; G01V 8/00; G01S 15/02

(52) U.S. Cl. CPC H02J 50/60; H02J 50/10; B60L 53/124; G01S 15/02; G01V 3/10; G01V 8/005; G01V 3/088

(57) ABSTRACT

An object protection for a wireless power transmission system and a method for operating a wireless power transmission system are disclosed. In an embodiment a wireless power transmission system includes a detection system configured to be sensitive to a material selected from the group consisting of a dielectric material and a metallic material and to monitor at least two parameters selected from the group consisting of a presence of an object, a distance of the object, a temperature of the object, a thermal behavior of the object, a presence of a metallic object, a presence of a dielectric object, and a coverage of the detection system with metallic or dielectric matter, wherein the detection system includes at least one or more sensors selected from the group consisting of an infrared sensor, an ultrasonic sensor, a capacitive sensor and an inductive sensor.

This patent application is a national phase filing under section 371 of PCT/EP2017/065435, filed Jun. 22, 2017, which is incorporated herein by reference in its entirety.

### TECHNICAL FIELD

The present invention refers to the field of wireless power transmission, in particular to detecting objects and matter in the vicinity of a wireless power transmission system.

### BACKGROUND

Wireless power transmission systems can be used to transfer electric power from a primary assembly to a secondary assembly without the need for a direct electrical connection between the primary assembly and the secondary assembly. The secondary assembly can be arranged in an electric device that should be powered by the primary assembly. Via such wireless power transmission systems, devices such as mobile communication devices and electric vehicles can be powered. In particular, the battery of an electric vehicle can be charged during operation of the wireless power transmission systems.

In particular when a high power rate is needed, e.g. to charge a large capacity battery of an electric vehicle, objects or matter in the vicinity of the wireless power transmission system can disturb the operation. Further, the high power rate can heat up objects such as metallic objects or harm living matter in the vicinity of the wireless power transmission system.

From International Patent Application Nos. WO 2016/099806 A1 and WO 2016/060748 A1, the use of radar transceivers to determine the presence of a vehicle and to support alignment of the vehicle is known.

### SUMMARY OF THE INVENTION

Embodiments provide a wireless power transmission system that can detect the presence of foreign objects such as living objects or metallic objects. Embodiments further provide to monitor the whole area of a wireless power transmission system. Yet other embodiments provide to monitor the transmission system's environment during operation of the wireless power transmission system.

The wireless power transmission system comprises a detection system. The detection system is sensitive to a material selected from a dielectric material or a metallic material. The detection system allows monitoring of at least two parameters selected from the presence of an object, the distance of an object, the temperature of an object, the thermal behavior of an object, the presence of a metallic object, the presence of a dielectric object, and the coverage of the detection system with metallic or dielectric matter. The detection system has at least one or more sensors selected from an infrared sensor, an ultrasonic sensor, a capacitive sensor, and an inductive sensor.

Such a wireless power transmission can, due to the presence of its detection system, detect foreign objects and living objects in the vicinity of the transmission system. Such a wireless power transmission system can fulfill the safety requirements that are necessary for wireless power transmission systems. Further, it is possible that such a wireless power transmission system determines the presence of any living object or any foreign object in the vicinity. Such a system can determine the distance between the system and the respective object. It is possible to monitor the temperature of a detected object continuously or iteratively. Thus, the thermal development of the object can be observed. Thus, e.g. a metallic object is in the vicinity of the wireless power transmission system and magnetic power is transferred to the metallic object and the metallic object is heated up then this scenario can be recognized and the corresponding counteractions can be started.

It is possible that at least one sensor of the wireless power transmission system is immune to magnetic and/or electric fields.

Especially when a wireless power transmission system that provides a high power rate is operating, then strong magnetic fields are emitted. These strong magnetic fields are problematic for a plurality of known sensors or known wireless power transmission systems.

A result of intense studies in the field of sensor systems for wireless power transmission systems is that a combination of sensors and a concentration of sensors in sensor blocks can be obtained in such a way that the sensors can monitor the wireless power transmission systems environment while the power transmission system is active.

Accordingly, it is possible that the wireless power transmission system comprises a plurality of sensor blocks. Each sensor block comprises at least one or more sensors. Each sensor block is arranged at a position of the perimeter of the wireless power transmission system. Each sensor block is aligned to monitor a different segment of the environment of the wireless power transmission system.

The sensors inside the sensor blocks and the sensor blocks relative to the wireless power transmission system are arranged in such a way that the magnetic fields emitted by the transmission system will not harm the sensors. Only little noise is induced to the sensors.

To describe the observable area of a sensor or a respective sensor block, the use of a spherical coordinate system can be useful. In a spherical coordinate system, the position, i.e., the direction and the distance, of an object relative to a center of the coordinate system is characterized by a horizontal azimuthal angle φ, a polar angle Θ and the distance r. Further, the solid angle is a measure for specifying the combination of observable directions.

Correspondingly, it is possible that the sensors of the wireless power transmission system are arranged and aligned in such a way that material selected from the dielectric material and the metallic material can be monitored for each azimuthal angle φ in the range between 0° and 360°.

Further, it is possible that the sensors are arranged and aligned in such a way that the material selected from the dielectric material and the metallic material can be monitored for each polar angle Θ between 0° and 90°.

The observable area of a single sensor may be the volume of a cone or a spherical segment being equivalent to a certain solid angle.

Usually, a single sensor does not have an observable volume corresponding to a solid angle of a hemisphere (solid angle: n) or a whole sphere (solid angle: 2n).

Thus, the sensor system has a plurality of sensors that may be distributed over the different sensor blocks and the sensors and the sensor blocks are arranged such that—at least for a certain minimum distance r—each possible combination of Θ and φ determining a position can be seen by at least one sensor.

It is possible that the wireless power transmission system comprises one or more infrared sensors. Each infrared sensor can have an observable area characterized by a field view angle between 120° and 150° in the horizontal plain and in the vertical plain. The search depth of the infrared sensors can be between 2 m and 4 m.

It is possible that the field view angle is 135° in the horizontal plain and in the vertical plain and the search depth is 3 m.

Furthermore, it is possible that the wireless power transmission system comprises one or more ultrasonic sensors. Each ultrasonic sensor can have an observable area characterized by a field view angle between 80 and 100° in the horizontal plain and in the vertical plain. A search depth can be between 1 m and 3 m.

It is possible that the field view angle in the horizontal plain and in the vertical plain of an ultrasonic sensor is 90°. The search depth can be 2 m.

It is possible that the wireless power transmission system has one or more capacitive sensors. Each capacitive sensor can have a search depth between 3 cm and 8 cm.

It is possible that the search depth of a capacitive sensor is around 5 cm.

It is possible that the wireless power transmission system has one or more inductive sensors. Each inductive sensor can have a search depth between 3 cm and 8 cm.

The search depth of an inductive sensor can be around 5 cm.

One or more infrared sensors can comprise an infrared light source, e.g. an LED, and an infrared receiving circuit element, e.g. also an LED.

Further, an infrared sensor can comprise a thermopile.

Infrared sensors using LEDs as a light source are active sensors while infrared sensors utilizing thermopiles are passive sensors that can comprise active circuitry to amplify a sensor reading.

Capacitive sensors can be utilized to determine whether a dielectric matter is in the vicinity of the wireless power transmission system. Thus, it can be determined whether the power transmission system is covered by water, snow, mud, leaves, etc. Capacitive sensors can detect metallic objects as well.

The inductive sensors can be utilized to determine whether metallic objects are in the vicinity of the wireless power transmission system.

Further, the wireless power transmission system can comprise a control and processing circuit that is electrically connected to the sensors. The evaluation circuit is provided for evaluating the sensor readings.

Embodiments provide a method of operating a wireless power transmission system comprises the steps: monitoring the system's environment utilizing a plurality of two or more sensors before activating a primary coil, monitoring the system's environment during normal operation, and reducing the power rate if the presence of an unwanted object is realized.

The method can be a method of living object protection and foreign object detection.

The method can further comprise the step shutting down the wireless power transmission system when a critical condition is detected.

A critical condition can be the detection of a human or a living object, water, mud etc. in the vicinity.

The wireless power transmission system can have a primary assembly with a primary coil with a mainly rectangular or squared housing outer shape. The edges of the primary assembly can establish the perimeter of the wireless power transmission systems where sensors or sensor blocks are arranged

It is possible that each patch of the rectangular housing outer shape has two sensor blocks. However, it is also possible that each edge of the footprint has one sensor block. Furthermore, one additional sensor block can be positioned at a corner of the rectangular housing outer shape. Thus, a total number of eight sensor blocks can be provided as part of one power transmission system.

A heat sensor or an infrared sensor utilizing a thermopile can comprise the thermopile and two operational amplifiers. The driver circuit having the two operational amplifiers can have a supply terminal and an output terminal. An output of a first operational amplifier is connected to the non-inverted input port of the second operational amplifier. The output of the second operational amplifier can be connected to the output terminal. The thermopile has three terminals. One terminal is connected to the supply terminal. A second terminal of the thermopile is connected to the non-inverted input port of the first operational amplifier. The third terminal of the thermopile is electrically connected to ground. Between the non-inverted input of the first operational amplifier and ground, a capacitive element and a resistive element are connected in series. Between the inverting input of the first operational amplifier and ground, a resistive element and a capacitive element are connected in series. Between the output terminal of the first operational amplifier and the in-verting input terminal of the first operational amplifier, a resistive element, a capacitive element and a diode are electrically connected in parallel. Such a feedback circuit is also present for the second operational amplifier. Further, between the inverting input terminal of the second operation amplifier and ground, a resistive element and a capacitive element are connected in series.

An ultrasonic sensor can have a single ultrasonic transducer or two or more ultrasonic transducers.

In an embodiment with two ultrasonic transducers, one transducer can be utilized as a transmitter and the respective other transducer can be used as a receiving element. In a first time period, a plurality of ultrasonic pulses is emitted by the first transducer. After that, in a second interval, echoes of the pulses are received and from the echoes, distances of objects can be determined.

A version of an ultrasonic sensor having two ultrasonic transducers can comprise two circuit blocks. The first circuit block has a first support terminal and a second support terminal. The second circuit block has an output terminal and is connected to ground. The second circuit block is electrically connected to the second supply terminal of the first circuit block.

The first circuit block has an operational amplifier and a transistor. The second circuit block has an operational amplifier.

In the first circuit block, the ultrasonic transducer has two terminals. One terminal is connected to the first supply terminal via a resistive element. The second terminal of the transducer is connected to ground. The transistor is electrically connected to the first terminal of the transducer via a resistive element. Another resistive element is connected between the output terminal of the operational amplifier and the transistor. Further, another resistive element is electrically connected between the transistor and ground. Between the second supply terminal and ground, two resistive elements are connected in series. The first of these two resistive elements is connected between the second supply terminal and the non-inverting terminal of the operational amplifier. The second resistive element is electrically connected between the non-inverting input terminal and the inverting input terminal of the operational amplifier. Between the inverting input terminal of the operational amplifier and the second supply terminal, two resistive elements are electrically connected in series.

The second circuit block has a first terminal of the transducer electrically connected to the non-inverting input terminal of the operational amplifier of the second block. The second terminal of the transducer is electrically connected to the inverting input terminal of the operational amplifier via a series connection with a capacitive element and a resistive element. In a feedback circuit between the output of the operational amplifier and the inverting terminal of the operational amplifier, a resistive element is connected.

Also, a resistive element is connected between the output terminal of the operational amplifier and the output terminal of the sensor. Between the output terminal of the sensor and ground, a capacitive element is connected. Between the second supply terminal and the non-inverting input terminal of the operational amplifier of the second block, a series connection of two resistive elements are connected. A node between these two resistive elements is connected to ground via a resistive element.

A version of an ultrasonic sensor that needs only one ultrasonic transducer comprises three operational amplifiers, four capacitive elements, one diode, fourteen resistive elements, and three inductive elements. Such a sensor has a first supply terminal that expects a voltage of 3.3 V and a second supply terminal expecting a voltage of 5 V, relative to ground.

Working principles and details of preferred embodiments are described in the accompanying schematic figures.

### BRIEF DESCRIPTION OF THE DRAWINGS

In the figures.

FIG. 1 shows a possible basic distribution of components of a wireless power transmission system WPTS.

FIG. 2 shows another possible distribution of components.

FIG. 3 shows a version of a wireless power transmission system including an evaluation circuit.

FIG. 4 shows an equivalent circuit diagram of an infrared/heat sensor utilizing a thermopile.

FIG. 5 shows an equivalent circuit diagram of an ultrasonic sensor utilizing two ultrasonic transducers.

FIG. 6 shows time dependent activities of the two transducers.

FIG. 7 shows an equivalent circuit diagram of an ultrasonic sensor that needs only a single ultrasonic transduce.

FIG. 8 illustrates the meanings of azimuth angle φ and polar angle Θ in a spherical coordinate system.

### DETAILED DESCRIPTION OF ILLUSTRATIVE EMBODIMENTS

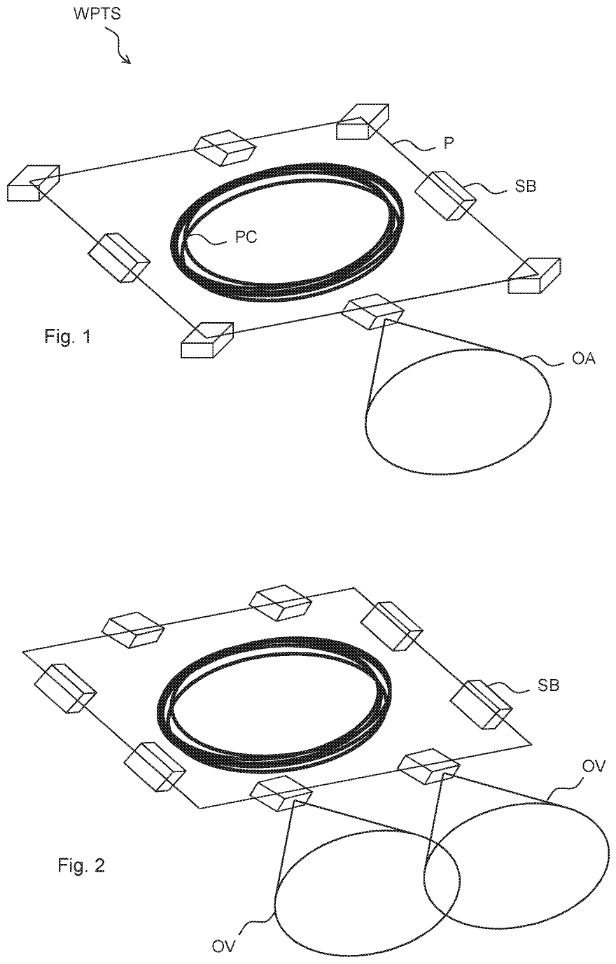

FIG. 1 shows possible positions of sensors and sensor blocks SB of a wireless power transmission system WPTS. The wireless power transmission system can have a mainly rectangular footprint. Within the footprint, a primary coil PC for transmitting magnetic energy is arranged. The perimeter n of the footprint has a rectangular shape with four edges and four corners. It is possible that each corner and each edge has one sensor block SB that carries the sensors. The sensor blocks and the sensors within the sensor blocks are arranged and aligned in such a way that as much as possible of the environment can be monitored, e.g. one sensor of one sensor block SB can have an observation area OA as illustrated as a cone. The plurality of sensors within the plurality of sensor blocks allows arranging corresponding observation areas that overlap in such a way that a solid angle of n, i.e., the upper hemisphere, can be observed.

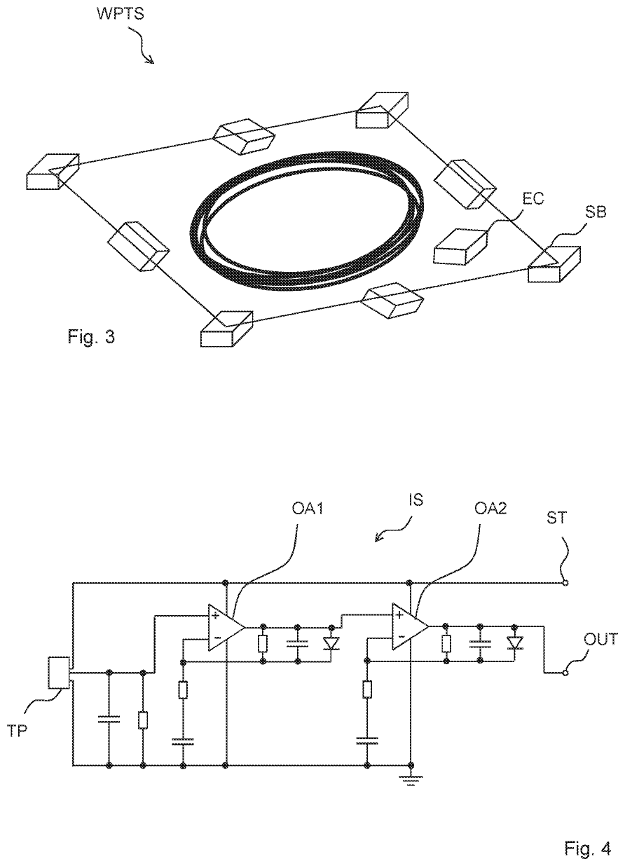

FIG. 2 shows a possible arrangement of sensor blocks SB where each of the four edges of the mainly rectangular footprint carries two sensor blocks SB. Again, the sensor blocks and the sensors within the sensor blocks are arranged and aligned such that observation areas or observation volumes OV are positioned relative to each other that any position that has a minimum distance to the center of the wireless power transmission system is monitored and observed by at least one sensor.

FIG. 3 illustrates an embodiment of a wireless power transmission system having an evaluation circuit EC that comprises circuitry to evaluate the sensor readings from the sensors within the sensor blocks SB. The results determined by the evaluation circuit EC can be provided to a central processor unit of the wireless power transmission system.

FIG. 4 shows a possible equivalent circuit diagram of a heat sensor using a thermopile TP. The sensor has a supply terminal ST and an output terminal OUT. Such a sensor is one embodiment of an infrared sensor IS.

The driver circuit of the sensor has two operational amplifiers electrically connected in series between one terminal of the thermopile TP or the output port OUT. That is, the thermopile TP is electrically connected to the non-inverting input terminal of the first operational amplifier. The output terminal of the first operational amplifier is electrically connected to the non-inverting input terminal of the second operational amplifier. The output terminal of the second operational amplifier is electrically connected to the output terminal OUT.

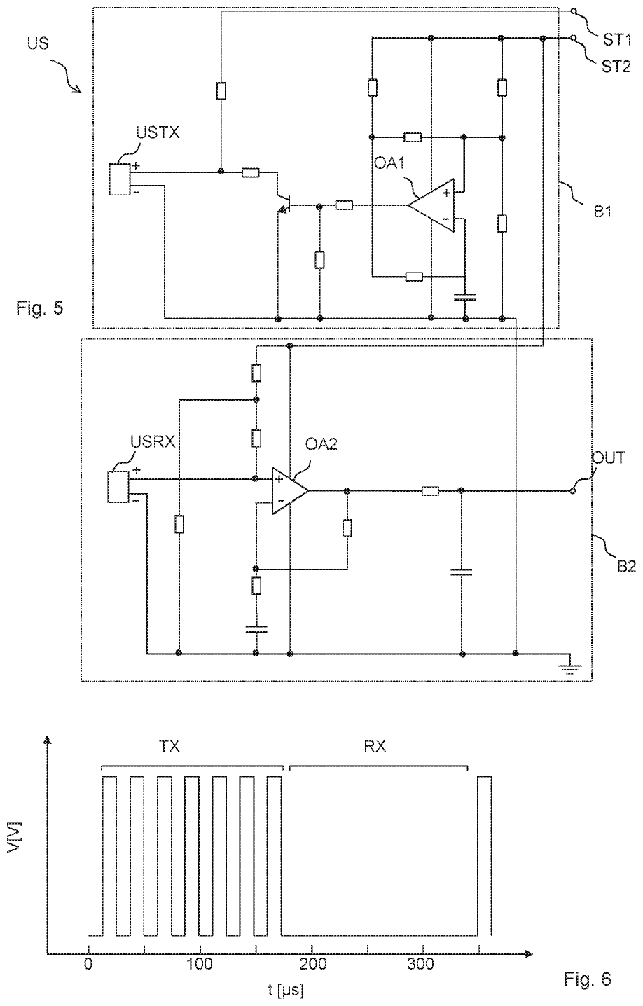

FIG. 5 shows a possible equivalent circuit diagram of an ultrasonic sensor US. The sensor US has a first ultrasonic transducer USTX that may be utilized as a transmitter. Further, the sensor US has a second ultrasonic transducer USRX that may be utilized as a reception unit. A first circuit block B1 comprises circuit elements associated with the first ultrasonic transducer USTX. A second circuit block B2 comprises circuit elements associated with the second ultrasonic transducer USRX. The first block B1 has a first operational amplifier OA1. The second block B2 has a second operational amplifier OA2.

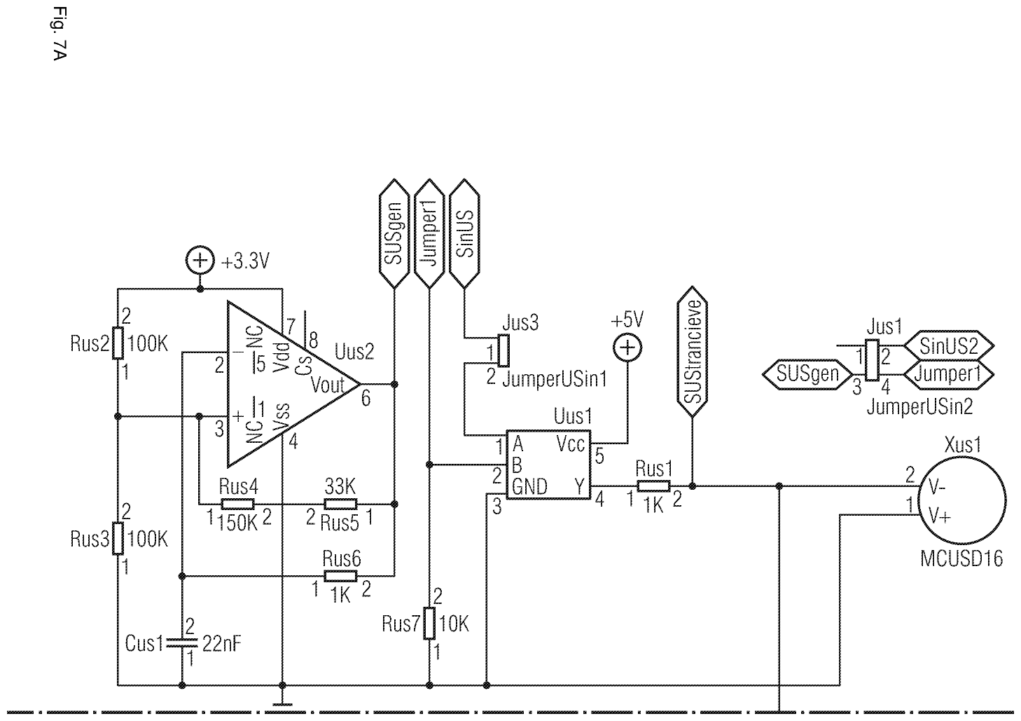

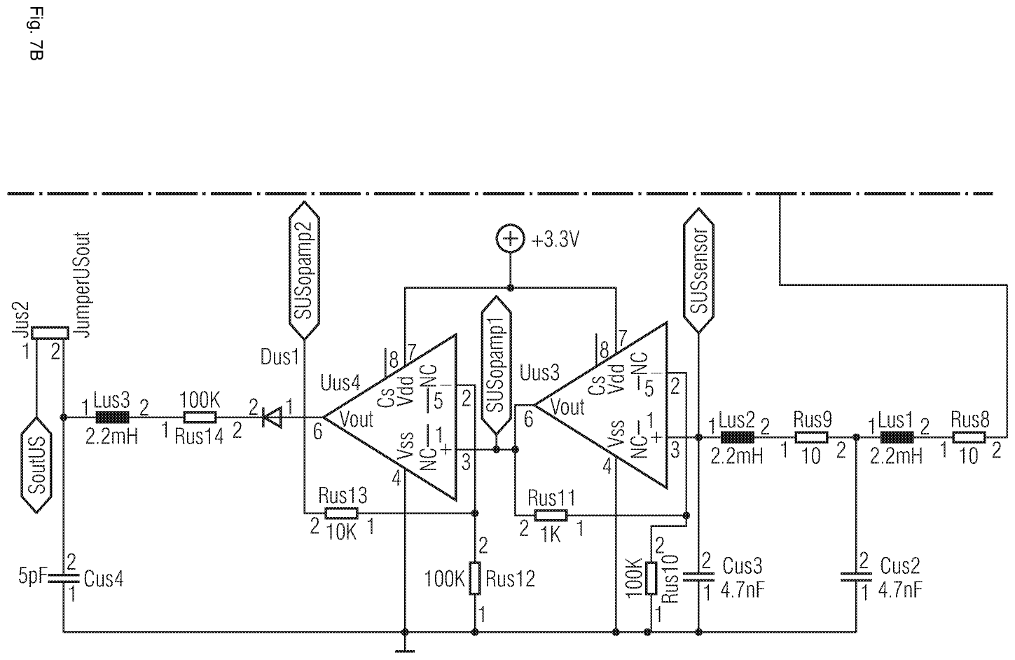

FIG. 6 illustrates a possible mode of operation where in a first time period TX, voltage pulses are transmitted to the sensor US which converts electric energy to acoustic energy. Thus, ultrasonic pulses corresponding to the voltage pulses are emitted by the first transducer USTX. After that, a time period of reception RX is needed without activity of the transmitter. In this time period, echoes of possible objects near the wireless power transmission systems are received. From the time needed for the pulses to be reflected and received by the reception transducer USRX, the distance between the object and the respective sensor of the wireless power transmission system can be determined.

FIG. 7 shows a possible equivalent circuit diagram of an ultrasonic sensor utilizing a single ultrasonic transducer USTXRX that can act as a transmitter and a receiver. The driver circuit of this ultrasonic sensor US has three operational amplifiers OA and the circuit elements establishing interconnections between input ports, supply terminals, the terminals of the operational amplifiers OA and the transducer USTXRX.

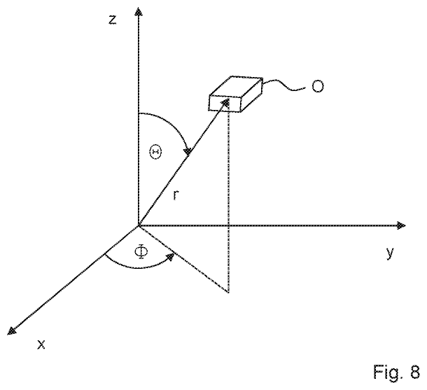

FIG. 8 illustrates the meaning of the quantities φ, Θ, r to determine a position in a spherical coordinate sys-tern. Angle φ determines the angle of the rotation within the xy-plain, i.e., within the horizontal plain. Angle Θ determines the rotation away from the z-axis. R determines the distance between the center of the coordinate system and the respective object o.

The wireless power transmission system is not limited to the embodiments and details described above. The method for operating a transmission system is not limited to the steps described above.

### LIST OF REFERENCE SIGNS

B1: first circuit block
B2: second circuit block
EC: evaluation circuit
IS: infrared sensor/thermal sensor
o: object
OA: observable area
OA: operational amplifier
OUT: output terminal
OV: observable volume
P: perimeter
PC: primary coil
r: distance
SB: sensor block
ST: supply terminal
ST1: first supply terminal
ST2: second supply terminal
t: time
US: ultrasonic sensor
USRX: reception transducer
USTX: transmission transducer
USTXRX: common transceiver transducer
V: voltage
WPTS: wireless power transmission system
Θ: polar angle
φ: horizontal/azimuthal angle

1-11. (canceled)

12. A wireless power transmission system comprising:
a detection system configured to:
be sensitive to a material selected from the group consisting of a dielectric material and a metallic material; and
monitor at least two parameters selected from the group consisting of a presence of an object, a distance of the object, a temperature of the object, a thermal behavior of the object, a presence of a metallic object, a presence of a dielectric object, and a coverage of the detection system with metallic or dielectric matter,
wherein the detection system comprises at least one or more sensors selected from the group consisting of an infrared sensor, an ultrasonic sensor, a capacitive sensor and an inductive sensor.

13. The wireless power transmission system of claim 12, wherein at least one sensor is immune to magnetic and/or electric fields.

14. The wireless power transmission system of claim 12, wherein the wireless power transmission system comprises a plurality of sensor blocks, wherein each sensor block comprises at least one or more sensors, wherein each sensor block is arranged at a position of a perimeter of the wireless power transmission system (WPTS), and wherein each sensor block is aligned to monitor a different segment of an environment of the wireless power transmission system.

15. The wireless power transmission system of claim 12, wherein the sensors are arranged and aligned to monitor the material for each azimuthal angle ϕ in a range [0°, 360°].

16. The wireless power transmission system of claim 12, wherein the sensors are arranged and aligned to monitor the material for each polar angle θ in a range [0°, 90°].

17. The wireless power transmission system of claim 12, wherein the wireless power transmission system comprises one or more infrared sensors, and wherein each infrared sensor has an observable area characterized by a field view angle between 120° and 150° in a horizontal plane and in a vertical plane and a search depth between 2 m and 4 m.

18. The wireless power transmission system of claim 12, wherein the wireless power transmission system comprises one or more ultrasonic sensors, and wherein each ultrasonic sensor has an observable area characterized by a field view angle between 80° and 100° in a horizontal plane and in a vertical plane and a search depth between 1 m and 3 m.

19. The wireless power transmission system of claim 12, wherein the wireless power transmission system comprises one or more capacitive sensors, and wherein each capacitive sensor has search depth between 3 cm and 8 cm.

20. The wireless power transmission system of claim 12, wherein the wireless power transmission system comprises one or more inductive sensors, and wherein each inductive sensor has search depth between 3 cm and 8 cm.

21. The wireless power transmission system of claim 12, further comprising a control and processing circuit electrically connected to the sensors and configured to evaluate sensor readings.

22. A method for operating a wireless power transmission system, the method comprising:
monitoring a system environment utilizing a plurality of two or more sensors before activating a primary coil;
monitoring the system environment during normal operation; and
reducing a power rate when a presence of an unwanted object is realized.

23. A wireless power transmission system comprising:
a detection system configured to:
be sensitive to a material selected from the group consisting of a dielectric material and a metallic material; and
monitor at least two parameters selected from the group consisting of a presence of an object, a distance of the object, a temperature of the object, a thermal behavior of the object, a presence of a metallic object, a presence of a dielectric object and a coverage of the detection system with metallic or dielectric matter,
wherein the detection system comprises at least one or more sensors selected from the group consisting of an infrared sensor, an ultrasonic sensor, a capacitive sensor and an inductive sensor,
wherein the sensors are arranged and aligned to monitor the material for each azimuthal angle ϕ in a range [0°, 360°], and
wherein the sensors are arranged and aligned to monitor the material for each polar angle θ in a range [0°, 90°].

24. A wireless power transmission system comprising:
a detection system that configured to be:
sensitive to a material selected from the group consisting of a dielectric material and a metallic material; and
monitor at least two parameters selected from the group consisting of a presence of an object, a distance of the object, a temperature of the object, a thermal behavior of the object, a presence on a metallic object, a presence of a dielectric object, and a coverage of the detection system with metallic or dielectric matter,
wherein the detection system comprises at least one or more sensors selected from the group consisting of an infrared sensor, an ultrasonic sensor, a capacitive sensor, an inductive sensor,
one or more infrared sensors, wherein each infrared sensor has an observable area characterized by a field view angle between 120° and 150° in a horizontal plane and in a vertical plane and a search depth between 2 m and 4 m; and
one or more capacitive sensors, wherein each capacitive or inductive sensor has a search depth between 3 cm and 8 cm.
